(19) United States
(12) Patent Application Publication
(10) Pub. No.: US 2025/0103687 A1
(43) Pub. Date: Mar. 27, 2025

(54) METHOD FOR AUTHENTICATING AN OBJECT

(71) Applicant: TRINAMIX GMBH, Ludwigshafen (DE)

(72) Inventors: Nicolas WIPFLER, Ludwigshafen (DE); Peter SCHILLEN, Ludwigshafen (DE); Benjamin GUTHIER, Mannheim (DE)

(21) Appl. No.: 18/729,596

(22) PCT Filed: Feb. 1, 2023
(86) PCT No.: PCT/EP23/52395

§ 371 Date: Jul. 17, 2024

(30) Foreign Application Priority Data
Feb. 15, 2022 (EP) 22156831.4

(51) Int. Cl. G06F 21/30; G06T 7/13; G06T 7/70; G06V 10/145; G06V 10/771

(52) U.S. Cl. CPC G06F 21/30; G06T 7/13; G06T 7/70; G06V 10/145; G06V 10/771; G06T 2207/20081; G06T 2207/20084; G06T 2207/20132

(57) ABSTRACT

Disclosed herein is a method for authenticating an object. A pattern image is received showing the object while it is illuminated with a light pattern including one or more pattern features. From the pattern image pattern features located on the object are selected based on information indicating the position and extend of the object in the pattern image, several cropped pattern images are generated by cropping the pattern image based on the selected pattern features, where a cropped pattern image has a predetermined size and contains at least a part of one of the selected pattern features. The object is the authenticated by providing the cropped pattern images to a machine learning based identification model which has been trained such that it can authenticate an object based on the cropped pattern images as input. The authentication of the object is then outputted.

### FIELD OF THE INVENTION

The invention relates to a method, an apparatus and a computer readable data medium for authenticating an object. Further, the invention refers to a training method, a training apparatus and a training computer readable data medium for training a machine learning based identification model suitable for authenticating an object, such that the identification model is utilizable by the method, apparatus and computer readable data medium for authenticating an object. Further, the invention relates to a use of the authentication of an object obtained by the method for authenticating an object for access control.

### BACKGROUND OF THE INVENTION

Generally, it is known that neural networks can be trained to detect if an image contains a desired object, for example, a real face or a spoofing mask, in particular, for identification purposes in an unlocking process. However, it has turned out that for the training of such neural networks a large number of images are required and still a poor recognition reliability is often obtained. Moreover, the huge number of input images for training the neural network in this approach easily leads to an overfitting of the neural network and thus to a further decrease in accuracy.

It would thus be advantageous if it were possible to train the neural network with less training data thus avoiding overfitting and at the same time increasing the identification accuracy of the neural network for authenticating an object.

### SUMMARY OF THE INVENTION

It is an object of the present invention to provide a method, an apparatus and a computer readable data medium for accurately authenticating an object that allows to utilize less training data for training a machine learning based identification model for authenticating the object. Moreover, it is further an object of the invention to provide a training method, a training apparatus and a computer readable data medium that allow to provide an identification model that is usable in the method, apparatus and computer readable data medium for authenticating an object by training the identification model utilizing less training data and less computational resources.

In a first aspect of the present invention, a computer implemented method for authenticating an object is presented, wherein the method comprises i) receiving a pattern image showing the object while it is illuminated with a light pattern comprising one or more pattern features, ii) selecting from the pattern image pattern features located on the object based on information indicating the position and extend of the object in the pattern image, iii) generating several cropped pattern images by cropping the pattern image based on the selected pattern features, wherein a cropped pattern image has a predetermined size and contains at least a part of one of the selected pattern features, iv) authenticating the object by providing the cropped pattern images to a machine learning based identification model which has been trained such that it can authenticate an object based on the cropped pattern images as input, and v) outputting the authentication of the object.

Since several cropped pattern images are generated by cropping the pattern image such that each cropped pattern image having a predetermined size contains at least a part of one selected pattern feature that is selected such that it is located on the object, and since the cropped pattern images are utilized as input into a machine learning based identification model, not the complete pattern image including, in particular, also potential huge amounts of background is utilized for the authentication. In particular, the cropped pattern images are already focused on the object to be authenticated without including substantial amounts of background. Thus, the part of the training process of the identification model that is necessary to train the identification model to differentiate between the object and a potential very variable background can be avoided leading to a decrease in the necessary training data. Moreover, the cropping of the pattern image into smaller sections, i.e. the dividing of the object to be authenticated into several images each showing only a part of the object, has the further advantage that during training of the machine learning based identification model it can be avoided that the authentication is based strongly on a correlation of features in completely different areas of the object. In this context, it has been found that the cropping of the pattern image forces the identification model to base the authentication only on correlations of features that are near to each other on the object, i.e. can be found in the same area of the object, which leads to a higher authentication accuracy. Furthermore, it has been found that the cropping of the pattern image allows to utilize machine learning models with less parameters, for instance, with less neurons in case of a neural network. This has the advantage that a danger of overfitting of the machine learning model can be decreased leading to a higher reliability of the output of the machine learning model. Thus, the method allows the authentication of an object with an increased accuracy and reliability utilizing a machine learning identification model that can be trained less computationally expensive, in particular, with less training data.

The method refers to a computer implemented method and can thus be performed by a general or dedicated computing device adapted to perform the method, for instance, by executing a respective computer program. Moreover, the method can also be performed by more than one computing device, for instance, by a computer network or any other kind of distributed computing, wherein in this case the steps of the method can be performed by one or more computing units.

The method allows for authenticating an object. Authenticating an object in particular refers to identifying a specific object for the purpose of determining whether the specific object has access to predetermined resources. Generally, identifying an object refers to determining an identity of the object. The identity can refer to a general identity, for instance, a class identity that indicates that the object is part of a predetermined object class, or a specific identity that refers to determining whether the object refers to a predetermined unique object. An example for determining a general identity of an object refers, for instance, to determining whether an object on an image is a human being, i.e. belongs to the class of human beings, or is a chair, i.e. belongs to the class of chairs. Examples for a specific identification can refer to identifying a predetermined individual, for instance, an owner of a smartphone, identifying a specific individual chair, for instance, a specific chair belonging to a specific owner, etc. Preferably, the method is adapted to authenticate a human being in order to allow access to locked resources with restricted access. In a preferred embodiment, the authentication of a human being is utilized to allow or deny access to a computing device, like a smartphone, laptop, tablet, etc. or recourses provided by the computing device, like a predetermined program, a digital payment option, etc.

In a first step, a pattern image showing the object is received. For example, the pattern image can be received from a camera unit taking the image while the object is illuminated with a light pattern. However, the pattern image can also be received from a storage unit on which the pattern image is already stored. Moreover, the pattern image can also be received by a user input, for instance, when a user indicates which of a plurality of images stored on a storage should be utilized as pattern image. The pattern image refers to an image that has been taken while an object is illuminated with a light pattern comprising one or more pattern features. For example, the taking of the pattern image can be initialized by a user by providing a respective input to a respective device, wherein in this case a light pattern generation unit can be adapted to generate the light pattern and the camera is adapted to take the pattern image while the object is illuminated with the light pattern. However, the generating of the light pattern and the taking of the image can also be automatic based on one or more predetermined event or can be continuous, for instance, for a product quality control.

Generally, the light pattern on the object can be generated by any kind of light pattern generating unit. Preferably, the light pattern is generated by utilizing laser light, in particular, infrared laser light. Utilizing infrared light has the advantage that this light is less irritating to a human user, when irradiating a face of the user. In particular, it is preferred that one or more vertical-cavity surface-emitting lasers (VCSEL) are utilized to generate a light pattern comprising a plurality of laser light spots. However, also other light sources can be utilized for generating the light pattern, for instance, LED light sources of one or more colors can also be utilized. Preferably, the light pattern illuminating the object refers to a regular light pattern comprising regularly arranged pattern features. However, in other embodiments the light pattern can also refer to an irregular pattern or even to an arbitrary pattern. Generally, a pattern feature of the light pattern refers to a part of the light pattern that can be differentiated from other pattern features, for instance, due to an unlighted distance between the pattern features or due to a different arrangement of the light in different pattern features. Preferably, a pattern feature refers to one or more light spots arranged in a predetermined pattern, wherein the light pattern is preferably repeating the predetermined pattern. In particular, it is preferred that the light pattern refers to a point cloud, wherein the points refer to light spots, wherein a pattern feature can in this case refer to one light spot. In this case, the light pattern can refer, for example, to a hexagonal or triclinic lattice of light spots that are substantially similar and comprise a circular shape. Utilizing hexagonal or triclinic patterns for the light spots has the advantage that the arrangement of the light spots provides different distance relations for the light spots, which prevents the danger that during training the machine learning based identification model is mislead by a too regular pattern. However, a pattern feature can also refer to more than one light spot, for instance, to one hexagon comprising six light spots, wherein in this case, for example, the feature patterns, i.e., the hexagons, can be repeated to form a regular light pattern.

The method then further comprises selecting from the pattern image pattern features located on the object based on information indicative of the position and extent of the object in the pattern image. Information indicative on the position and extent of the object in the pattern image can be received in a plurality of ways. For example, a pattern image can be presented to a user and the user can indicate the position and extent of the object in the pattern image optionally based on a visible light image of the object. Moreover, information from the pattern image, in particular, from the pattern features in the pattern image, itself can be utilized to determine the position and extent of the object. For example, in a preferred embodiment the selecting of the pattern features can comprise first deriving the information indicating the position and extent of the object from the pattern image. In this embodiment, known methods for deriving information from pattern images can be utilized. In a preferred embodiment known methods for determining a distance at which a pattern feature is reflected from the camera can be utilized for receiving information on the extent and position of the object. For example, pattern features within a predetermined distance range with respect to each other can be regarded as belonging to the same object and can thus be selected. Moreover, an outline of an object can be determined, for instance, by comparing the distance of pattern features neighbouring each other. The outline can then be determined if the distance of neighbouring pattern features lies above a predetermined threshold. Furthermore, in additional or alternative embodiments information indicating the position and extent of the object in the pattern image can also be derived from the pattern image by deriving materials from the reflective characteristics of each pattern feature. Also in this case already known methods for deriving material characteristics from characteristics of reflected light can be utilized and it can be determined that pattern features indicating a material associated with the object are selected as pattern features located on the object. For example, pattern features indicating that they are reflected by the skin of a human can in this case be determined as belonging to the face of a human and thus can be selected as being located on the object.

In a further additional or alternative embodiment it is preferred that further a flood light image is received and the selecting of the pattern features is based on determining an outline of the object indicative of the position and extend of the object based on the flood light image, and selecting the pattern features located on the object by selecting the pattern features lying within the outline, wherein the flood light image shows the object while it is illuminated with flood light. In this embodiment, alternative to a flood light image also a natural light image showing the object while illuminated by a natural light or artificial indoor light can be utilized. The determining of the outline of the object indicating the position and extent of the object based on the flood light image can be carried out in accordance with any known feature extraction method for visible light images. In particular, the image can be presented to a user and the user can indicate the outline of the object in the flood light image. However, also more sophisticated automatic algorithms, like machine learning algorithms or simple feature detection algorithms can be utilized. Generally, for all embodiments utilizing more than one image, for instance, more than one pattern image, for example, for a distance determination of feature patterns, or a flood light image for outline detection, it is preferred that the respective images are taken at the same time or at least in a predetermined time range around the time at which the pattern image has been taken and are moreover taken by the same camera or a camera comprising a predetermined distance to the camera taking the pattern image. This allows to directly derive from the position of features in one image, for instance, in a flood light image, the position of the feature in the pattern image. However, respective images can also be preprocessed. This can include determining the position and extent of the object in the image and centering, scaling, size normalizing and rotating the respective object such that a normalized orientation is provided for all images that allows to derive the position of a feature in one image and transfer this derived position to the other image. For example, in a flood light image the feature detection algorithm can detect an object and center the object in the image and scale the image to a normalized scale. In the pattern image, the distance measuring of the feature patterns can also be used to determine the outline of the object and also the pattern image can be preprocessed such that the object is centered and scaled to the normalized scale. Both images can then be utilized for transferring a position from one image to the other even if in the original images, for instance, due to a small movement of a user in front of the camera, the positions were slightly shifted. Generally, for the method to work accurately, the determination of the position and extend of the object has only to be approximated, i.e. no accurate determination of an outline is necessary. Thus, also methods that only approximate the position and extend of the object can be utilized or methods as described above can be utilized with less accuracy, for instance, with less computational resources.

The pattern features located on the object are then selected from the pattern image, for example, by determining whether the position of the pattern feature is located within an outline of the object. In this context, the selecting of the pattern features can also comprise determining the position of each pattern feature in the pattern image. For example, respective feature detection algorithms can be utilized. Since the pattern features have a predetermined shape and are further clearly distinguishable from other parts of the image not illuminated by the pattern features, such feature recognition methods can be based on easy rules. For example, it can be determined that a pixel of the pattern image comprising a light intensity over a predetermined threshold is part of a pattern feature. Moreover, also light intensities of neighbouring pixels can, depending on the geometric form of a pattern feature, be taken into account for determining the position of pattern features. Moreover, also a 2D shape recognition algorithm can be utilized to recognize the predetermined 2D shape of the pattern features. However, also more sophisticated feature extraction methods can be utilized, or a user can perform the position determination by a respective input. The pattern features on the object can then be selected by comparing the position of the pattern features with the indicated position and extend of the object and by selecting pattern features lying within the boundaries of the object.

However, in some embodiments, the determining of the position of the pattern features can also be omitted. For example, if the information on the extend and position of the object is derived for the pattern image itself, for example, by determining a distance of feature patterns with respect to each other, the selection can be based also directly on the distance determination. In particular, in this example, pattern features neighbouring each other and being within a predetermined distance range from each other can directly be selected as being on the object. Thus, in such cases no position of pattern features has to be determined.

In the further step based on the selected pattern features several cropped pattern images are generated by cropping the pattern image. Generally, the cropping of the image refers to removing all areas of the pattern image outside of the cropped pattern image. Preferably, the several cropped pattern images refer to at least two cropped pattern images, more preferably to more than two cropped pattern images. The cropping of the pattern images to generate several cropped pattern images is performed such that a cropped pattern image, for instance, each cropped pattern image, comprises a predetermined size and contains at least a part of one of the selected pattern features, preferably, one of the selected pattern features. A part of a selected pattern feature can refer, for example, to one half or one quarter of the selected pattern feature. In particular, it is not necessary that a complete selected pattern feature is part of a cropped image, since the algorithm can also be trained to authenticate the object based on cropped images comprising a part of a selected pattern feature. In particular, for cases in which a selected pattern feature refers to a laser spot light, the selected pattern feature will follow a Gaussian intensity function with a maximum intensity in the middle of the selected pattern feature. In such a case the identification model can base an authentication, for example, on characteristics of the intensity function, wherein also accurate authentications can be achieved if only parts of the intensity function, i.e. only parts of the selected pattern feature, are visible in a cropped image, since these parts already allow to determine the respective characteristics of the intensity curve. In a preferred embodiment, the pattern image is cropped such that a cropped image comprises parts of more than one selected pattern feature. For example, the pattern image is cropped by utilizing selected pattern features as boundary points for the cropping boundary of the cropped images. However, it is preferred that the pattern image is cropped such that a cropped image comprises at least one complete selected pattern image, in order to increase an accuracy of the authentication. The predetermined size can, for instance, be determined in form of a predetermined area that should be covered by a cropped image, or any other characteristic that can determine the size of an area, for instance, a radius in case of a circular area, etc. Preferably, the cropped images refer to rectangular images determined by a predetermined height and width. More preferably, the cropped images refer to quadratic images. This has the advantage that the information around a pattern feature is weighted the same in all directions. However, the cropped images can generally have any shape and can thus be characterized also by different size characterisations. For example, the cropped images can be circular and characterized by a respective radius. Preferably, each cropped image comprises the same predetermined size. However, for different cropped images also different predetermined sizes can be utilized, for example, for images cropped in a center of an object a larger size can be predetermined than for images cropped within a predetermined distance from the outline of the object. Preferably, a cropped pattern image is centered around a selected pattern feature. Even more preferably, for each selected pattern feature a cropped pattern image is generated comprising at least the respective selected pattern feature preferably centered within the cropped image. Further, it is preferred that a cropped pattern image comprises more than one selected pattern feature, for example, in addition to central pattern features also all or a part of the neighbouring selected pattern features.

In a further step, the method comprises authenticating the object by providing the cropped pattern images to a machine learning based identification model. The machine learning based identification model has been trained such that it can authenticate an object based on the cropped pattern images as input. Generally, a machine learning based identification model is trained utilizing cropped pattern images that have been generated in accordance with the same rules as the cropped pattern images that are later utilized for authenticating an object. The machine learning based identification model can utilize any known machine learning algorithm. However, neural networks are especially suitable for being utilized in the context of feature and object recognition techniques on images. Thus, it is preferred that the machine learning based identification model is based on a neural network algorithm. More preferably the neural network refers to a convolutional neural network. In this case, utilizing cropped pattern images is especially suitable as input for the machine learning based identification model, since the cropping of the pattern image prevents the convolutional neural network algorithm to base authentication decisions too strongly on correlations on features that lie in completely different regions of the image. This leads to a much higher authentication accuracy and to a decrease of false positive authentications. In a preferred embodiment the identification model is adapted to learn to differentiate between different materials in the pattern image based on characteristics of the pattern features that are reflected of a respective material and to base the authentication on the material differentiation. More details of such an identification model can be found, for instance, in the application WO 2020/187719 A1.

Due to its training the trained identification model can then authenticate an object when provided with the cropped pattern images as input. In particular, the output of the identification model can refer to a simple validation or non-validation or whether the object refers to a predetermined specific object like an individual person, or a general object class like a human being. However, the output can also refer to determining to which of a predetermined number of object classes or to which of a predetermined number of specific objects the authenticated object belongs. For example, it can then be determined that of three specific users A, B, C of a device the current user is identified as user A.

The result, i.e. the output of the identification model, can then be outputted. In particular, the method comprises a step of outputting the authentication of the object. For example, the result of the identification model, i.e. the authentication of the object, can be provided to an output unit of a user device providing a visual or audio output to a user to inform the user of the result. Moreover, the output can be further processed, for example, to unlock a door or device if it has been determined that the identity of the potential user allows for the respective access. Moreover, the output of the result of the authentication of the object can further be utilized to control a device not only to provide access to restricted resources, but further, for instance, to control movements or positions of automatic devices or robots based on an authentication of an object.

In a further aspect of the invention, an apparatus for authenticating an object is presented, wherein the apparatus comprises i) an input interface for receiving a pattern image showing the object while it is illuminated with a light pattern comprising one or more pattern features, ii) a processor configured to a) selecting from the pattern image pattern features located on the object based on information indicating the position and extend of the object in the pattern image, b) generating several cropped pattern images by cropping the pattern image based on the selected pattern features, wherein a cropped pattern image has a predetermined size and contains at least a part of one of the selected pattern features, and c) authenticating the object by providing the cropped pattern images to a machine learning based identification model which has been trained such that it can authenticate an object based on the cropped pattern images as input, and iii) an output interface for outputting the authentication of the object.

In a further aspect of the invention, a method for training a machine learning based identification model suitable for authenticating an object is presented, wherein the method comprises i) receiving a training dataset based on sets of historical data comprising a) cropped pattern images of an object and b) an authenticity of the object, wherein the cropped images are generated from a pattern image, wherein the pattern image shows the object while it is illuminated with a light pattern comprising one or more pattern features, and wherein the cropped pattern image generation comprises a) selecting from the pattern image pattern features located on the object based on information indicating the position and extend of the object in the pattern image, and b) generating several cropped pattern images by cropping the pattern image based on the selected pattern features, wherein a cropped pattern image has a predetermined size and contains at least a part of one of the selected pattern features, ii) training a trainable machine learning based identification model by adjusting the parameterization of the identification model based on the training dataset such that the trained identification model is adapted to authenticate an object when provided with cropped pattern images of the object as input, and iii) outputting the trained identification model.

In a further aspect of the invention, an apparatus for training a machine learning based identification model suitable for authenticating an object is presented, wherein the apparatus comprises i) an input interface for receiving a training dataset based on sets of historical data comprising a) cropped pattern images of an object and b) an authenticity of the object, wherein the cropped images are generated from a pattern image, wherein the pattern image shows the object while it is illuminated with a light pattern comprising one or more pattern features, and wherein the cropped pattern image generation comprises a) selecting from the pattern image pattern features located on the object based on information indicating the position and extend of the object in the pattern image, and b) generating several cropped pattern images by cropping the pattern image based on the selected pattern features, wherein a cropped pattern image has a predetermined size and contains at least a part of one of the selected pattern features, ii) a processor configured to train a trainable machine learning based identification model by adjusting a parameterization of the identification model based on the training dataset such that the trained identification model is adapted to authenticate an object when provided with cropped pattern images of the object as input, and iii) an output interface for outputting the trained identification model.

In a further aspect of the invention, a use of the authenticity of an object is presented, wherein the use of the authenticity of an object obtained by the method as described above comprises access control.

In a further aspect of the invention, a non-transitory computer-readable data medium is presented, wherein the data medium storing a computer program including instructions causing a computer to execute the steps of the method as described above.

In a further aspect of the invention, a non-transitory computer-readable data medium is presented, wherein the data medium storing a computer program including instructions causing a computer to execute the steps of the training method as described above.

In a further aspect of the invention a method for determining the authenticity of an object is presented, wherein the method comprises a) receiving a pattern image and a flood light image of the object, wherein the pattern image shows the object while it is illuminated with a light pattern and wherein the flood light image shows the object while it is illuminated with flood light, b) determining the outline of the object from the flood light image, c) selecting from the pattern image pattern features located on the object based on the outline obtained from the flood light image, c) generating several cropped images by cropping the pattern image, wherein a cropped image has a predetermined width and height and contains in its center one of the selected pattern features, d) determining the authenticity of the object by providing the cropped images to a neural network which has been trained with a historic dataset containing cropped images of objects, and e) outputting the authenticity of the object.

In a further aspect of the invention a system for determining the authenticity of an object is presented, wherein the system comprises a) an input for receiving a pattern image and a flood light image of the object, wherein the pattern image shows the object while it is illuminated with a light pattern and wherein the flood light image shows the object while it is illuminated with flood light, b) a processor configured to i) determining the outline of the object from the flood light image, ii) selecting from the pattern image pattern features located on the object based on the outline obtained from the flood light image, iii) generating several cropped images by cropping the pattern image, wherein a cropped image has a predetermined width and height and contains in its center one of the selected pattern features, iv) determining the authenticity of the object by providing the cropped images to a neural network which has been trained with a historic dataset containing cropped images of objects, and c) an output for outputting the authenticity of the object.

In a further aspect, a method for training a neural network suitable for determining the authenticity of an object is presented, wherein the method comprises a) receiving a training dataset based on sets of historical data comprising cropped images of an object and the authenticity of the object, wherein the cropped images are generated from a pattern image and a flood light image of the object, wherein the pattern image shows the object while it is illuminated with a light pattern and wherein the flood light image shows the object while it is illuminated with flood light, and wherein the cropped image generation comprises b) determining the outline of the object from the flood light image, selecting from the pattern image the pattern features located on the object based on the outline obtained from the flood light image, generating several cropped images by cropping the pattern image, wherein a cropped image has a predetermined width and height and contains in its center one of the selected pattern features, c) training a neural network by adjusting the parameterization according to the training dataset, and d) outputting the trained neural network.

It shall be understood that the methods as described above, the apparatus as described above and the computer-readable data media as described above for authenticating an object have similar and/or identical preferred embodiments, in particular, as defined in the dependent claims. Moreover, also the training methods as described above, the training apparatus as described above, and the training computer-readable data medium as described above have similar and/or preferred embodiments, in particular, as defined in the dependent claims.

It shall be understood that a preferred embodiment of the present invention can also be any combination of the dependent claims or above embodiments with the respective independent claim.

These and other aspects of the present invention will be apparent from and elucidated with reference to the embodiments described hereinafter.

### BRIEF DESCRIPTION OF THE DRAWINGS

In the following drawings:

FIG. 1 shows schematically and exemplarily an embodiment of a system comprising an apparatus for authenticating an object,

FIG. 2 shows schematically and exemplarily a flow chart of a method for authenticating an object,

FIG. 3 shows schematically and exemplarily a flow chart of a method for training an identification model for authenticating an object,

FIG. 4 shows schematically and exemplarily an image recording device,

FIG. 5 shows schematically and exemplarily an image processing device utilizable by the apparatus for authenticating an object,

FIG. 6 shows schematically and exemplarily a more detailed embodiment of a method for authenticating an object,

FIG. 7 shows schematically and exemplarily an image cropping according to the method for authenticating an object.

### DETAILED DESCRIPTION OF EMBODIMENTS

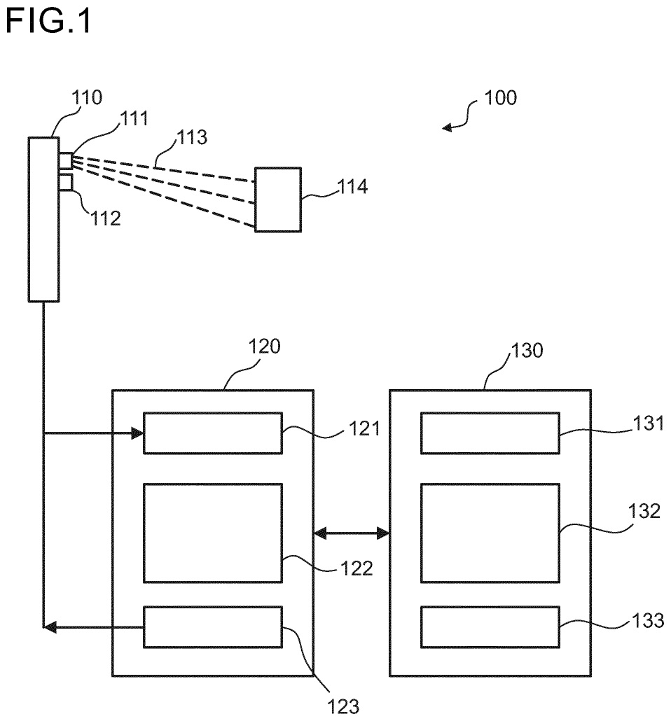

FIG. 1 shows schematically and exemplarily an embodiment of a system 100 comprising a locking device 110, an apparatus 120 for authenticating an object and a training apparatus 130 for training an identification model utilized in the apparatus 120. The locking device 110 schematically represents for a device or a part of a device that is adapted to manage an access of a user or an object to further resources. For example, the locking device 110 can be part of a user device like a smartphone and manage the access of users to the smartphone and/or the access of a user to the resources of the smartphone. However, the locking device 110 can also represent a door locking mechanism that is adapted to manage the access of persons to restricted areas, for instance, to an office building, a laboratory or other area. In a further example, the locking mechanism 110 could also refer to an access management system in a sorting facility in which a plurality of products are sorted in accordance with predetermined classes, wherein in this example the locking device 110 manages to which further procedure an authenticated object 114 gets access. According to the plurality of examples for the locking device 110, also the object 114 that should be authenticated can refer to any object. Preferably, the object 114 refers to a human being or a part of a human being like a face. However, the object can also refer to an inanimate object, like any kind of industrial product.

The locking device 110 comprises a light pattern generation unit 111 adapted to generate a light pattern 113 on at least one surface of the object 114. The light pattern can refer to any predetermined light pattern. However, preferably, the light pattern is generated by the light pattern generation unit 111 by utilizing infrared laser light. Generally, the light pattern 113 comprises a plurality of pattern features that refer to parts of the light pattern that together form the light pattern. Moreover, it is preferred that the light pattern refers to a regular light pattern of light spots as pattern features that can be arranged, for instance, in a triangular, cubic or hexagonal pattern. Further, the locking device 110 comprises a camera 112 that is adapted to receive light reflected by the object 114 that is illuminated with the light pattern 113 and to generate from the reflected light a pattern image of the object 114. In particular, the pattern image generated by the camera 112 shows the light pattern 113 reflected by the object 114.

Further, the system 100 comprises an apparatus 120 for authenticating an object. In this preferred example, the authentification of the object refers to an authenticating of the object, i.e. it is not only determined if the object refers to a predetermined object class but further whether the object 114 refers to a specific object, for instance, to a specific user. The apparatus 120 comprises an interface unit 121 for receiving input data, a processor 120 for generally processing the input data and an output interface 123 for generally outputting data. For example, the apparatus 120 can be part of the same user device as the locking device 110, for instance, can be part of the computing unit of a smartphone or tablet.

However, the apparatus can also be a standalone device, or can be part of a general network or server system and is in this case preferably communicatively coupled to the locking device 110.

The input interface is adapted to receive, in particular, the pattern image generated by the camera 112 of the locking device 110. Optionally the input interface can further be adapted to receive further data from the locking device 110 or from other devices, for instance, from a display. For example, if the camera 112 of the locking device 110 is further adapted to generate a visible light image of the object 114 not illuminated by the light pattern or a flood light image of the object 114 generated by the object 114 while it is illuminated by a flood light, the input interface can further be adapted to receive this additional image. Additionally or alternatively, the input interface can also receive information indicating a position and extent of the object 114 in the pattern image also from other devices, for instance, from a user input device on which a user inputs this information. The input interface 121 is then adapted to provide the received data to the processor 122 for further processing.

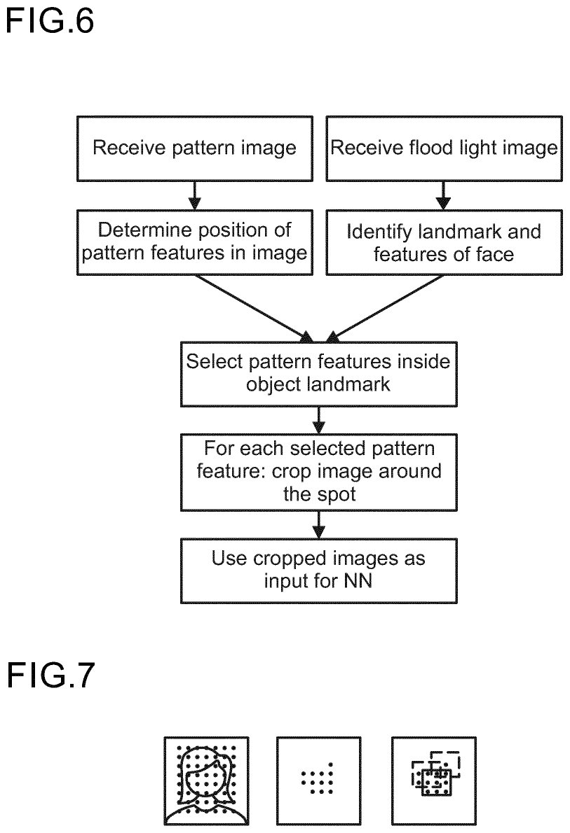

The processor 122 is then adapted, for instance, by executing respective computer control signals, to select from the pattern image pattern features located on the object. In particular, the selection of the pattern features is based on information indicating the position and extent of the object in the pattern image. Moreover, the selecting can also comprise determining, for example, via a feature recognition method, the position of the pattern features in the pattern image. For example, since the general light pattern utilized for illuminating the object 114 is known, respective known feature algorithms that are adapted to recognize the light pattern in the pattern image can be utilized. In particular, it is preferred that a trained machine learning algorithm is utilized for determining locations of pattern features in the pattern image. Further, the information indicating the position and extent of the object in the pattern image can be provided or determined in a plurality of different ways. For example, the information can be provided by a user based on the pattern image or based on a visible light image like a flood light image. For example, a user can utilize an input unit to indicate on a flood light image the position and extend of the object, for example, by tracing an outline of the object in the flood light image. In this case it is preferred that the flood light image has been taken such that no substantial difference between the position and extent of the object 114 between the pattern image and the flood light image is expected. The such indicated outline provides information on the position and extent of the object in the pattern image if a functional relation between positions in the pattern image and positions in the flood light image is known, for instance, since both are taken by the same camera or by cameras providing a predetermined functional relation. However, the selecting of the pattern features can also comprise a determining of the information indicating the position and extent of the object automatically. For example, the pattern features themselves allow for deriving information on reflective characteristics of an object 114. Thus, for instance, based on the pattern image it can be determined whether a pattern feature is reflected by a material referring to the expected material of the object 114 or by something different. An example, for this can be found, for example, in the application WO 2020/187719 A1. Thus, also based on the reflection characteristics of the pattern feature, information on the position and extent of the object can be determined. Moreover, pattern features utilizing laser light also allow for a distance determination of the distance between the reflection of the pattern feature visible in the pattern image and the camera. Since for most objects 114 it can be expected that all pattern features reflected by the object can be found within a predeterminable specific distance range to each other, whereas the pattern features reflected from a background of the object can be expected of showing a completely different distance pattern, also the distance information provided by the pattern features can be utilized to provide information indicating the position and extent of the object. Furthermore, also additional input can be utilized for deriving an information indicating the position and extent of the object, for instance, referring to a further pattern image, like in cases in which the distance of pattern features is determined utilizing two images taken from slightly different angles to utilize the Parallax effect for distance determination. Moreover, in a preferred embodiment that will be explained in detail with respect to FIGS. 5 and 6, a visual light image is provided, for instance, a flood light image, and utilized for determining the information on the position and extent of the object, in particular, to determine an outline of the object. Preferably, known feature recognition algorithms can be utilized for determining the position and extent of the object, for instance, by determining the outline of the object. In a preferred embodiment, a machine learning algorithm like a neural network is utilized that has been trained to determine outlines of objects in an image.

Based on the selected pattern features, several cropped pattern images are generated by cropping the pattern image. In particular, the pattern image is cropped such that a cropped pattern image comprises a predetermined size and contains at least a part of one selected pattern feature. Generally, the cropping can be performed in accordance with any predetermined rule that fulfils the above-mentioned conditions. The respective rules are generally the same rules that have been applied for cropping images with which the respective identification model for which the cropped pattern images are used as input has been trained with. However, it has been found that it is in particular advantageous for receiving an accurate authentication result with less training data that for each selected pattern feature a cropped pattern image is generated that centers around the selected pattern feature. Moreover, it is preferred that the size of the cropped pattern images is predetermined such that each cropped pattern image comprises at least two selected pattern features, more preferably comprises all neighboring pattern features of a pattern feature on which the cropped pattern image is centered, but small enough to not cover all selected pattern features. Generally, the optimal predetermined size for the cropped pattern images can base on the respective application, for instance, based on the object that should be authenticated. For example, such an optimal size can be found for a respective application, for instance, by training identification models with different sizes, respectively, and comparing the accuracy and reliability of the respectively trained identification models. However, the identification model can also work with a suitable accuracy with any size of the cropped images falling within the above mentioned range.

The such determined cropped pattern images are then provided as input to an identification model that is trained to provide as input based on the cropped pattern images an authentication of an object, in particular, to verify whether the object refers to a specific object or not. Preferably, the identification model is trained by utilizing a training apparatus 130 adapted to train a machine learning based identification model. The training apparatus 130 can be realized as part of the apparatus 120, for instance, utilizing the same processor and/or the same out- and input interfaces. However, the training apparatus 130 can also be realized as part of a completely different computing device, for instance, can be provided on a server or computing network, and is preferably then communicatively coupled to the apparatus 120 for providing the trained identification model to the apparatus 120.

Generally, the training apparatus 130 can comprise an input interface 131 for receiving a training data set for training the identification model. The training data set preferably refers to historical data comprising a) cropped pattern images of an object and b) an authenticity of the object. In particular, it is preferred that the training data set is provided accordingly for a plurality of different objects. The selection of the objects provided in the training data set can be based, for instance, on the intended application of the identification model. For example, if the identification model should be utilized to authenticate an individual user, the training data set can comprise a plurality of human faces and also a plurality of images of the individual user that should be authenticated and a respective authentication can be provided together with the cropped pattern images of the different user faces, for example, as annotation. Generally, for training the identification model the same rules for cropping the pattern images are applied that are later applied, for instance, by the apparatus 120 when the object 141 should be authenticated. Thus, also the cropped pattern images in the training data set can be generated in accordance with the above described principles and rules. The processor 132 of the training apparatus 130 is then configured to train the trainable machine learning based identification model based on the provided training data set, in particular, by adjusting a parameterization of the identification model. Preferably, the identification model is based on a neural network algorithm, in particular, on a convolutional neural network algorithm, and the parameterization refers to determining the respective parameters of the neutral network. In particular, any known training method for training respective machine learning based algorithms like neural networks or convolutional neural networks can be utilized by the processor 132. After the training process, the identification model is adapted to authenticate a respective object for which it has been trained when provided with cropped pattern images of the object as input. The such trained identification model can then be provided by the processor 132 to the output interface 133 of the training apparatus 130 for providing the identification model to the apparatus 120, in particular, to the processor 122 for authenticating the object 114.

The processor 122 then utilizes the identification model, for instance, that has been stored after having been provided by the training apparatus 130 on a local storage of the apparatus 120 and provides as input to the identification model the cropped pattern images. Based on the input cropped pattern images of the object 114, the identification model is then adapted to provide as output an authentication, of the object 114. This result of the authentication can then be outputted by the output interface 123 of the apparatus 120. In particular, the outputting can comprise providing the information of the authentication of the object to a user, for example, by a respective visual or audio output. However, it is preferred that the output is in particular provided to the locking device 120, wherein the locking device 120 is then adapted to manage a locking or unlocking of respective resources based on the determined authentication of the object. For example, if it is verified that the object 114, in particular, a user, has access to respective resources, the locking device 110 can be adapted to provide this access to the respective user. However, in the case in which it has been determined that the object 114 has no access to respective requested resources, the locking device 110 can be adapted to deny the respective access.

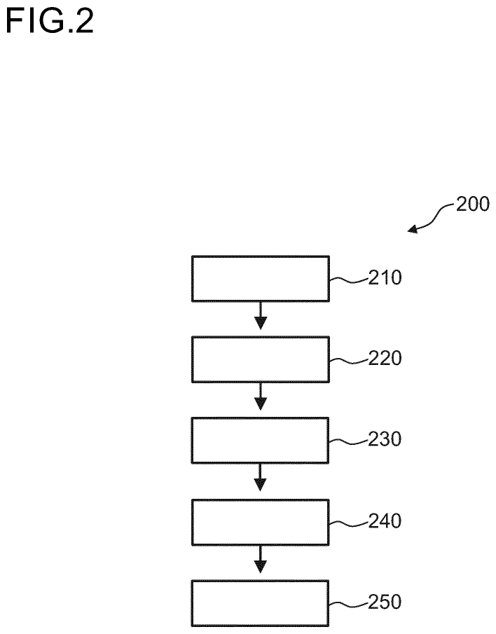

FIG. 2 shows schematically and exemplarily a computer implemented method 200 of authenticating an object. In particular, the computer implemented method 200 comprises the functions as explained above with respect to the apparatus 120 shown in FIG. 1. In a first step 210, the method 200 comprises receiving a pattern image showing the object while it is illuminated with the light pattern comprising one or more pattern features. In step 220, pattern features that are located on the object are then selected from the pattern image based on information indicating the position and extent of the object in the pattern image. Further, in a step 230 several cropped pattern images are generated by cropping the pattern image based on the selected pattern features. In particular, the cropped pattern images are generated in accordance with the principles and rules as explained above with respect to FIG. 1. Moreover, in step 240, the object is authenticated by providing the cropped pattern images as input to a machine learning based identification model which has been trained such that it can authenticate an object based on the cropped pattern images as input. In step 250, the result provided by the identification model, i.e. the authentication of the object, is provided as output, for instance, in order to use the authentication for unlocking resources.

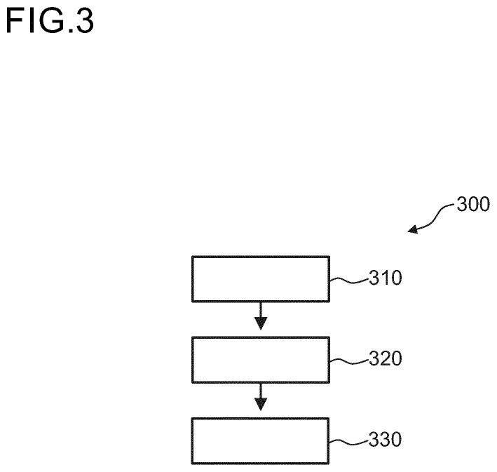

FIG. 3 shows schematically and exemplarily a computer implemented method 300 for training a machine learning based identification model that is suitable for authenticating an object and being used in the method as described with respect to FIG. 2. In particular, the method 300 comprises in a first step 310 of receiving a training data set based on historical data that comprises a) cropped pattern images of an object and b) an authentication of the object. In particular, the training data set can be provided in accordance with the rules and principles described above with respect to the training apparatus 130 in FIG. 1. In step 320, the trainable machine learning based identification model is then trained by adjusting the parameterization of the identification model based on the training data set such that the trained identification model is adapted to authenticate an object when provided with cropped images of the object as input. In step 330, the trained identification model can then be outputted, for instance, can be provided to the apparatus 120 as described with respect to FIG. 1.

In the following, some further preferred more detailed embodiments of the invention will be described. Generally, neural networks can be trained to detect if an image contains a desired object, for example a real face or a spoofing mask as authentication for an unlock process. However, if the whole image is used as input, a large number of images are required and still a poor recognition reliability is often obtained. Moreover, the huge number of input parameters in the neural network required in this approach easily leads to overfitting.

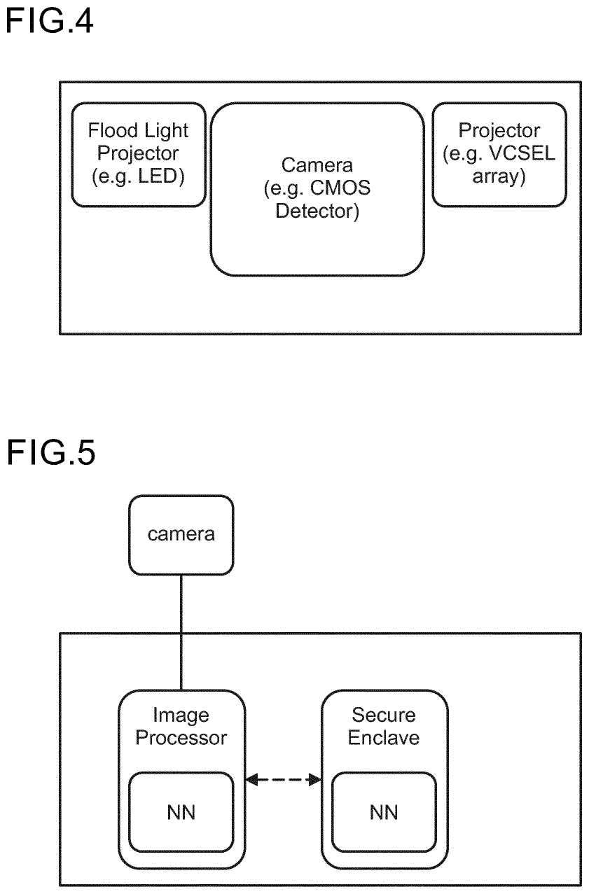

The inventors have found that the above problems can be solved by dividing a pattern image into partial pattern images and only use those partial pattern images which contain the object to be authenticated. For this purpose, in a preferred embodiment, an image recording device, for example a cell phone, can be provided with two projectors, one for illuminating flood light, e.g. an LED, and one for illuminating a light pattern, e.g. a VCSEL array, as shown in FIG. 4. A camera of the image recording device can then capture at one point in time the object illuminated by flood light and at another point in time illuminated by light patterns. These images, i.e. the pattern image and the flood light image, are then passed to an image processor which can be configured to execute a neural network. The image processor can refer to a realization of the processor 122 of the apparatus 120 described with respect to FIG. 1. In a preferred embodiment the processor is adapted to perform at least the image processing in a secure environment to avoid external access to the operation. A schematic example of such a system is illustrated in FIG. 5.

FIG. 6 shows a preferred example of a respective image processing for determining cropped pattern images. In this example, in a first step preferably two different images are received from the object, i.e. a pattern image and a flood light image. For generating the pattern image the object is illuminated with patterned light and recorded with a corresponding camera, e.g. an IR camera. The pattern is typically regular, i.e. comprises repeated features. Particularly preferred patterns are point clouds, for example hexagonal or tricline lattices of spots which are somewhat similar to a circular shape. For generating the flood light image the object is illuminated with flood light or, optionally, just illuminated by ambient light, and recorded with a corresponding camera.

In the laser spot image, i.e. the pattern image, the position of each laser spot can be determined, for example, by determining local intensity maxima in the pattern image. In the flood light image, the object can be identified by its shape. There are various known methods for this, for example, convolutional neural networks trained for a certain kind of object, for example, a face. However, also methods not based on machine learning methods can be utilized, for example, rule based methods. Once, the object is identified in the flood light image, the images can further be preprocessed. This preprocessing can include shifting the object to the center, scaling it to a normalized size and/or rotating it to a normalized orientation.

The information about the outline of the object of interest from the flood light image can then be used to indicate the position and extend of the object in the pattern image and this to find those pattern features, such as light spots, in the pattern image which are located on the object. Preferably, for each such pattern feature, the pattern image is cropped such that the cropped pattern image shows the pattern feature in the center and a preset amount of the neighborhood of the pattern feature. Preferably, a cropped image will not only contain the central pattern feature, but also some of the neighboring feature. The chosen cropping size is a compromise between overfitting of the neural network if too large images are cropped and too low accuracy of the object recognition if too small images are cropped. Hence, the size of the cropped images can be chosen based on the requirements for a particular use case.

FIG. 7 illustrates an example of a cropping for a face image. For simplicity and a better illustration of the principle, on the left image in FIG. 7, the flood light image and the patterned image are superimposed. The outline of the face is identified from the flood light image, so only those spots of the laser spot image can be selected which hit the face area. This selection is illustrated in the central image of FIG. 7. Now, for each light spot as pattern feature a cropped image is generated having the light spot in the center and further comprising a certain neighborhood around the light spot. For three spots, the respective boundary boxes are shown in the right image of FIG. 7.

The set of partial images obtained by cropping around pattern features are used as input for a neural network which has been trained with an historic dataset generated in the same way described above. This approach has the advantage that the neural network needs significantly fewer input parameters and hence also fewer nodes. This leads to a decreased demand for training images, i.e. images for which is known if they contain the object of interest or not as well as spoofing images. Also, the risk of overfitting the network is decreased leading to a higher recognition accuracy. In particular if convolutional neural networks (CNN) are used, this cropping approach suppresses relations of object features which are far apart. These are usually not very useful for the authentication of an object, but rather the short-distance relations are important.

The trained neural network can then be used to authenticate the object. An example is the face recognition in which an image of a person is taken and evaluated if it is really the person which is entitled to enter a certain application or if it is a different one or a spoofing mask of the entitled person. In this case, the neural network uses the input as described above and may have as output the decision if this is the correct person or not.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the receiving of the pattern image, the selecting of the feature patterns, the cropping of the pattern image, the determining of the authenticity of the object, etc. performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a classical computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances, structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. Any embodiments herein are described with reference to acts that are performed by one or more processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network. A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that at least parts of the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, main-frame computers, mobile telephones, PDAs, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that at least parts of the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

The invention refers to a method for authenticating an object. A pattern image is received showing the object while it is illuminated with a light pattern comprising one or more pattern features. From the pattern image pattern features located on the object are selected based on information indicating the position and extend of the object in the pattern image, Several cropped pattern images are generated by cropping the pattern image based on the selected pattern features, wherein a cropped pattern image has a predetermined size and contains at least a part of one of the selected pattern features. The object is the authenticated by providing the cropped pattern images to a machine learning based identification model which has been trained such that it can authenticate an object based on the cropped pattern images as input. The authentication of the object is then outputted.

1. A computer implemented method for authenticating an object wherein the method comprises:
receiving a pattern image showing the object while it is illuminated with a light pattern comprising one or more pattern features,
selecting from the pattern image pattern features located on the object based on information indicating the position and extend of the object in the pattern image,
generating several cropped pattern images by cropping the pattern image based on the selected pattern features, wherein a cropped pattern image has a predetermined size and contains at least a part of one of the selected pattern features,
authenticating the object by providing the cropped pattern images to a machine learning based identification model which has been trained such that it can authenticate an object based on the cropped pattern images as input, and
outputting the authentication of the object.

2. The method according to claim 1, wherein further a flood light image is received and the selecting of the pattern features is based on determining an outline of the object indicative of the position and extend of the object based on the flood light image, and selecting the pattern features located on the object by selecting the pattern features lying within the outline, wherein the flood light image shows the object while it is illuminated with flood light.

3. The method according to claim 1, wherein the pattern image is cropped such that a cropped pattern image is centered around a selected pattern feature.

4. The method according to claim 1, wherein for each selected pattern feature a cropped pattern image is generated comprising at least the respective selected pattern feature.

5. The method according to claim 1, wherein the size of a cropped image is determined by a predetermined height and width.

6. The method according to claim 1, wherein the machine learning based identification model is based on a neural network algorithm.

7. The method according to claim 1, wherein the light pattern refers to a regular pattern comprising regularly arranged pattern features.

8. The method according to claim 1, wherein a pattern feature refers to one or more light spots arranged in a predetermined pattern, wherein the light pattern is based on a repeating of the predetermined pattern.

9. The method according to claim 1, wherein the light pattern is generated by utilizing laser light, preferably, infrared laser light.

10. An apparatus for authenticating an object, wherein the apparatus comprises
an input interface for receiving a pattern image showing the object while it is illuminated with a light pattern comprising one or more pattern features,
a processor configured to
select from the pattern image pattern features located on the object based on information indicating the position and extend of the object in the pattern image,
generate several cropped pattern images by cropping the pattern image based on the selected pattern features, wherein a cropped pattern image has a predetermined size and contains at least a part of one of the selected pattern features, and
authenticate the object by providing the cropped pattern images to a machine learning based identification model which has been trained such that it can authenticate an object based on the cropped pattern images as input, and
an output interface for outputting the authentication of the object.

11. A method for training a machine learning based identification model suitable for authenticating an object, wherein the method comprises:
receiving a training dataset based on sets of historical data comprising
a) cropped pattern images of an object and
b) an authenticity of the object, wherein the cropped images are generated from a pattern image, wherein the pattern image shows the object while it is illuminated with a light pattern comprising one or more pattern features, and wherein the cropped pattern image generation comprises a) selecting from the pattern image pattern features located on the object based on information indicating the position and extend of the object in the pattern image, and b) generating several cropped pattern images by cropping the pattern image based on the selected pattern features, wherein a cropped pattern image has a predetermined size and contains at least a part of one of the selected pattern features,
training a trainable machine learning based identification model by adjusting the parameterization of the identification model based on the training dataset such that the trained identification model is adapted to authenticate an object when provided with cropped pattern images of the object as input, and
outputting the trained identification model.

12. An apparatus for training a machine learning based identification model suitable for authenticating an object, wherein the apparatus comprises:
an input interface for receiving a training dataset based on sets of historical data comprising
a) cropped pattern images of an object and
b) an authenticity of the object, wherein the cropped images are generated from a pattern image, wherein the pattern image shows the object while it is illuminated with a light pattern comprising one or more pattern features, and wherein the cropped pattern image generation comprises a) selecting from the pattern image pattern features located on the object based on information indicating the position and extend of the object in the pattern image, and b) generating several cropped pattern images by cropping the pattern image based on the selected pattern features, wherein a cropped pattern image has a predetermined size and contains at least a part of one of the selected pattern features,
a processor configured to train a trainable machine learning based identification model by adjusting a parameterization of the identification model based on the training dataset such that the trained identification model is adapted to authenticate an object when provided with cropped pattern images of the object as input, and
an output interface for outputting the trained identification model.

13. A method of using the authenticity of an object obtained by the method according to claim 1, the method comprising using the authenticity of the object for access control.

14. A non-transitory computer-readable data medium storing a computer program including instructions causing a computer to execute the steps of the method according to claim 1.

15. A non-transitory computer-readable data medium storing a computer program including instructions causing a computer to execute the steps of the method according to claim 1.

16. The method according to claim 2, wherein the cropped pattern image is centered around a selected pattern feature.

17. The method according to claim 6, wherein the machine learning based identification model is based on a convolution neural network.

18. The method according to claim 9, wherein the light pattern is generated by utilizing infrared laser light.
